(19) United States
(12) Patent Application Publication
(10) Pub. No.: US 2021/0079495 A1
(43) Pub. Date: Mar. 18, 2021

(54) PROCESS FOR THE RECOVERY OF COBALT, LITHIUM, AND OTHER METALS FROM SPENT LITHIUM-BASED BATTERIES AND OTHER FEEDS

(71) Applicants: Urban Mining Pty Ltd, West Perth (AU); NMR 360 Inc, Ville St. Laurent (CA)

(72) Inventors: Bryn Harris, Alexandria (CA); Carl White, Ville-Saint-Laurent (CA)

(21) Appl. No.: 16/620,191

(22) PCT Filed: Jun. 8, 2018
(86) PCT No.: PCT/AU2018/050568

§ 371 Date: Dec. 6, 2019

Related U.S. Application Data
(60) Provisional application No. 62/516,819, filed on Jun. 8, 2017.

(51) Int. Cl. C22B 7/00; C22B 26/12; C22B 3/00; C22B 3/42; H01M 10/54

(52) U.S. Cl. CPC C22B 7/007; C22B 26/12; C22B 7/005; C22B 3/42; H01M 10/54; C22B 23/043

(57) ABSTRACT

A processes is disclosed for the recovery of cobalt, lithium and associated metals from lithium-ion batteries, comprising (i) shredding and pulverising the batteries under an inert atmosphere, (ii) leaching the batteries with sulphuric acid and sulphur dioxide under reducing conditions with a sub-stoichiometric amount of acid, (iii) recovery of copper by cementation, (iv) purification of the leach filtrate to precipitate iron and aluminium, along with some of the manganese and nickel if they are at low levels in the feed battery, (v) ion exchange to remove residual copper, nickel and manganese, (vi) precipitation of the purified solution with soda ash to recover all of the cobalt, and (vii) recovery of lithium as carbonate.

### FIELD OF THE INVENTION

The present invention relates generally to processes for the recovery of the various metallic and metallic oxide components contained in spent lithium-based batteries, especially cobalt. It is also understood that such processes may be equally applied to other lithium and cobalt-containing feed materials.

### BACKGROUND OF THE INVENTION

The use of rechargeable Li-ion batteries has been growing steadily, and this growth will increase considerably as electric cars become more reliable and available, coupled with the demand for off-peak mass electric power storage. Until recently, because of the relatively low volume, there has been little interest in developing processes for the recovery and recycling of the various components in modern batteries, but this is now changing, and there will be a need for low-cost, efficient recycling processes, particularly for the more complex metal/metal oxide components.

A process developed by Umicore, for which a commercial operation was commissioned in 2011, was described by Jan Tytgat in a presentation to the Joint EC/Green Cars Initiative PPP Expert Workshop held in Brussels, December 2011, entitled “Umicore Battery Recycling: Recycling of NiMH and Li-ion Batteries, A Sustainable New Business”, and based on the corresponding US Patent Application 2012/0240729 A1 by Karel Verscheure, Mieke Campforts and Maurits van Camp, entitled “Process for the Valorisation of Metals from Li-Ion Batteries”, published on Sep. 27, 2012.

The process is basically a pyrometallurgical one, wherein the spent batteries are smelted to recover the cobalt into a metallic phase, which is periodically tapped. Other components in the batteries, such as aluminium and lithium report to the slag phase and are lost. As-designed and commissioned, Umicore made no attempt to recover lithium from this process, deeming it not to be worthwhile. For Umicore, this is a viable process, given that it is already a major producer of cobalt, so that the recovery of cobalt blends in with an existing business.

Dowa Eco-Systems in Japan describe a process in US Patent Application 2013/0287621 A1, by Koji Fujita, Satoshi Kawakami, Yoshihiro Honma and Ryoei Watanabe, entitled “Method for Recovering Valuable Material from Lithium-Ion Secondary Battery, and Recovered Material Containing Valuable Material”, published Oct. 31, 2013. In this process, the spent batteries are roasted, and are separated by physical means into various components. As with the Umicore process above, the main focus is on the recovery of cobalt.

Retriev Technologies, in U.S. Pat. No. 8,882,007 B1, entitled “Process for Recovering and Regenerating Lithium Cathode Material From Lithium-Ion Batteries”, by W. Novis Smith and Scott Swoffer, published on Nov. 11, 2014, describe a process wherein the original lithium cathode material is regenerated. This process is also fundamentally pyrometallurgical, requiring a “low-temperature” (relative to smelting) roasting step combined with physical separation. Additional lithium hydroxide is then added to return the lithium content of the recovered cathode material to its original composition. It is not really a recovery process as such, but rather one of refurbishing the original component.

More recently, methods of recovering lithium from ores such as spodumene have been disclosed. Guy Bourassa et al., in U.S. Pat. No. 9,382,126 B1, entitled “Process for Preparing Lithium Carbonate”, published on Jul. 5, 2016, describe a method wherein lithium is extracted into a sulphate solution. The solution undergoes various precipitation and ion exchange purification steps familiar to those skilled in the art to generate a pure lithium sulphate solution, which then undergoes electrolysis, to produce a lithium hydroxide solution/slurry. This slurry is then treated with pressurised carbon dioxide to generate pure lithium carbonate.

Yatendra Sharma, in World International Property Organisation Application WO 2016/119003 A1, entitled “Processing of Lithium Containing Material Including HCl Sparge”, published on Aug. 4, 2016, describes a very similar process, but in a chloride medium. Lithium is extracted into a chloride solution, which undergoes various precipitation and ion exchange purification steps familiar to those skilled in the art, including salting out of potassium and sodium via sparging with HCl gas, to generate a pure lithium chloride solution. This then undergoes electrolysis to produce a lithium hydroxide solution/slurry, which is treated with pressurised carbon dioxide to generate pure lithium carbonate. Preparation of dry HCl gas for salting out is an expensive process.

Electrolysis, whether carried out in sulphate or chloride, is also an expensive operation, and requires the capture of various gases such as chlorine or oxygen-containing mist from the cell. Carbonation, using pressurised carbon dioxide, is an inefficient operation, and is also expensive, requiring as it does that the carbon dioxide be pressurised in order to be used.

J. H. Canterford, in an article entitled “Cobalt Extraction from Manganese Wad by Leaching and Precipitation”, published in Hydrometallurgy Volume 12 (1984), pages 335-354, describes one such process. The dissolved metals were then recovered in bulk by sulphide precipitation to separate them from the impurities.

More recently, Pratima Meshram et al., in an article entitled “Comparison of Different Reductants in Leaching of Spent Lithium Ion Batteries”, published in JOM, Volume 68, Number 10, October 2016, pages 2613-2623, showed that reductants were necessary to improve the leaching of especially cobalt from spent batteries in sulphuric acid. They concluded that both hydrogen peroxide (acting as a reductant) and sodium bisulphite were effective, with the latter being preferred.

A second article by the same authors, entitled “Hydrometallurgical Processing of Spent Lithium Ion Batteries (LIBs) in the Presence of a Reducing Agent with Emphasis on Kinetics of Leaching”, published in Chemical Engineering Journal 281 (2015), pages 418-427, describe a method of recovering cobalt from the leach solutions by precipitation of cobalt oxalate with oxalic acid. However, the considerable co-precipitation of nickel oxalate occurred, giving a cobalt purity of ˜95%. Manganese and nickel were recovered as carbonates, but the purity was not disclosed. Under the conditions described in the article, it would be highly surprising if pure compounds were obtained.

Akitoshi Higuchi et al., in a similar article entitled “Selective Recovery of Lithium from Cathode Materials of Spent Lithium Ion Battery”, published in the same magazine, pages 2624-2631 noted that simpler metals recovery processes than presently exist are strongly required. Their somewhat surprising approach was to attempt to selectively recover the lithium, rather than the much more valuable cobalt. This was achieved by employing highly oxidising leaching conditions using sodium persulphate. High recoveries of lithium were obtained, whilst suppressing the dissolution of the other metallic components.

Daniel A. Bertuol, et al., in an article entitled “Recovery of Cobalt from Spent Lithium-ion Batteries Using Supercritical Carbon Dioxide Extraction”, published in Waste Management 51 (2016), pages 245-251, describe a novel method of extracting cobalt from spent batteries using supercritical carbon dioxide in conjunction with sulphuric acid and hydrogen peroxide. High extractions (>95%) of cobalt were achieved, and the cobalt was subsequently recovered as metal by electrowinning at >99% purity. There is no mention of the other constituents of the battery, and since metal of high purity was obtained, it is assumed that the other constituents did not leach under these conditions.

Eric Gratz, Qina Sa, Diran Apelian and Yan Wang, in an article entitled “A Closed Loop Process for Recycling Spent Lithium Ion Batteries”, published in Journal of Power Sources 262 (2014), pages 255-262, describe a process for recycling spent batteries. Their mode of recovery is to precipitate a combined nickel-cobalt-manganese hydroxide, the composition of which is then adjusted to re-create the original battery material.

Heesuk Ku, et al., in an article entitled “Recycling of Spent Lithium-ion Battery Cathode Materials by Ammoniacal Leaching”, published in Journal of Hazardous Materials 313 (2016), pages 138-146, describe a process wherein a cocktail of ammonium compounds, namely hydroxide, carbonate and sulphite (as the reductant) are used to dissolve the cobalt. All of the cobalt and copper was reported to dissolve, whereas very little manganese and aluminium was leached. Surprisingly, since it readily an ammine complex along with cobalt and copper, only a portion of the nickel dissolved. The behaviour of lithium was not reported, but under strongly alkaline conditions, it would not be expected to dissolve. The recovery of the metals from the leach solution was not reported.

Yet another method for dissolving the cathode material from batteries was reported by G. P. Nayaka, et al., in an article entitled “Dissolution of Cathode Active Material of Spent Li-ion Batteries Using Tartaric Acid and Ascorbic Acid Mixture to Recover Co”, published in Hydrometallurgy 161 (2016), pages 54-57. The organic acids mixture was reported to completely dissolve cathode material of spent LCO (i.e. LiCoO₂) batteries, with cobalt being recovered as oxalate from the leach solution. Only the behaviour of cobalt and lithium were reported, with the emphasis on cobalt. It is not known whether the other valuable components of spent batteries, namely manganese and nickel, would behave similarly to cobalt.

Francesca Pagnanelli et al., in an article entitled “Cobalt Products from Real Waste Fractions of End of Life Lithium Ion Batteries”, published in Waste Management 51 (2016), pages 214-221, report on a more conventional methodology for the recovery of cobalt from battery leach solutions using a series of solvent extraction reagents. D2EHPA is used for the removal of impurities. and Cyanex 272 for the recovery of cobalt. Both of these reagents require extensive pH control, particularly in concentrated solutions. It is interesting to note that the solution concentrations were not given in the article.

Another method for recovering cobalt and lithium is describe by Eliana G. Pinna, et al., in an article entitled “Cathodes of Spent Li-ion Batteries: Dissolution with Phosphoric Acid and Recovery of Lithium and Cobalt from Leach Liquors”, published in Hydrometallurgy 167 (2017), pages 66-71. In this approach, both cobalt and lithium are dissolved in phosphoric acid solutions, with lithium subsequently recovered as lithium phosphate and cobalt as oxalate.

Basudev Swain, in an article entitled “Recovery and Recycling of Lithium: A Review”, published in Separation and Purification Technology 172 (2017), pages 388-403, has reviewed all the technologies used for lithium recovery from various sources. The article concludes that there is no existing techno-economically viable process for the recovery of lithium and associated metals from spent lithium-ion batteries.

Zita Takacova, et al., in an article entitled “Cobalt and Lithium Recovery from Active Mass of Spent Li-ion Batteries: Theoretical and Experimental Approach”, published in Hydrometallurgy 163 (2016), pages 9-17 concluded that chloride was a better lixiviant than sulphate, and that lithium was extracted in preference to cobalt. The article focussed on leaching only, and there was no attempt made to recover either of the metals from solution. It is somewhat surprising that chloride would be regarded as being preferable to sulphate, since cobaltic oxide is a very strong oxidant, capable of oxidising hydrochloric acid to chlorine, so that substantial amounts of chlorine would be expected to be liberated in such a process.

It is apparent from the foregoing that despite there being a wide variety of proposed methods for treating spent lithium-ion batteries, there is not as yet any universal process, or combination of processes, for treating the increasing variability of these batteries. Early batteries were predominantly lithium-cobalt, with the cobalt value being many times that of lithium, hence the focus on recovering cobalt, which can be achieved quite easily pyrometallurgically, or by such processes as oxalate precipitation or solvent extraction. However, the recovered cobalt is relatively impure, and pyrometallurgical processes consume considerable amounts of energy, as well as generating greenhouse gases. The reported hydrometallurgical processes are ill-defined, and there is no consensus as to an accepted route.

More recently, there has been increasing interest in recovering lithium as well as cobalt, such that there is now a crossover with primary lithium processing. The process of Retriev Technologies, as do some others referred to above, simply attempt to re-create the original cathode of the battery, thus limiting its general applicability, since the technology of batteries is changing, and cathode materials are evolving considerably, with the incorporation, for example, of manganese, nickel, aluminium, iron and phosphorus.

As the amount of spent batteries will increase considerably in the future, along with the number of different types, there is, therefore, a need for a simple, omnivorous process that can accommodate the various elements in the batteries, as well as recovering these elements in a form useful for the further manufacture of batteries. Of particular importance is the purity of the recovered material, because electrochemical processes, such as those fundamental to battery operation, demand high levels of purity if they are to be efficient.

In view of the above, it is desirable to provide a process for improving the recovery of at least cobalt while avoiding one or more of the problems of prior art processes.

Reference to any prior art in the specification is not an acknowledgment or suggestion that this prior art forms part of the common general knowledge in any jurisdiction or that this prior art could reasonably be expected to be understood, regarded as relevant, and/or combined with other pieces of prior art by a skilled person in the art.

### SUMMARY OF THE INVENTION

In one aspect of the invention, there is provided a method for recovering metals from waste Co and Li-containing feed including:

subjecting shredded and/or pulverised Co and Li-containing feed to a sulphuric acid leach and sparging with SO₂ gas to form a slurry including a leachate of soluble metal salts and a solid residue, wherein the soluble metal salts are a mixture of Co- and Li-salts and other metal salts in the form of metal sulphites and metal sulphates;

separating the leachate and the solid residue;

treating the leachate with an air sparge to oxidise and/or convert at least some of the soluble metal salts to insoluble metal salts, and form a Co- and Li-containing leachate and a precipitate of insoluble metal salts;

separating the Co- and Li-containing leachate and the precipitate of insoluble metal salts;

treating the Co- and Li-containing leachate with a precipitant to form an Li-containing leachate and a Co-containing precipitate; and

separating the Co-containing precipitate from the Li-containing leachate.

In a preferred form of the invention, the waste lithium and cobalt containing feed is spent lithium-based batteries.

In an embodiment, the method further includes subjecting the waste Co- and Li-containing materials to a shredding and/or pulverising process to form the shredded and/or pulverised waste Co and Li-containing feed. The shredding and/or pulverising process should be conducted under anoxic conditions, such as under an inert atmosphere (e.g. a CO₂ atmosphere). Spent Li-batteries, in particular, may explode or catch fire if exposed to oxygen during shredding and/or pulverising.

The inventors have found that providing SO₂ during the sulphuric acid leach is particularly advantageous. Co, Ni and Mn in waste lithium batteries are mostly in their higher oxidation states, for example Co(III), Ni(III), and Mn(IV). However, oxides of these are not easily directly soluble in acids, and therefore require reductive leaching. SO₂ is effective in this respect, and is able to reduce these metals to more soluble oxidation states e.g. Co(II), Ni(II), and Mn(II). Equation (1) below shows the reductive leach for Co(III) to Co(II):

2Co₂O₃+4SO₂+O₂→4CoSO₄ (1)

In view of the above, in an embodiment, the sulphuric acid leach and sparging with SO₂ are conducted under anoxic conditions.

In an embodiment, sufficient sulphuric acid solution is added during the leach to provide a cobalt concentration of about 40 g/L to about 100 g/L.

In an embodiment, a sub-stoichiometric amount of sulphuric acid is used in the sulphuric acid leach, based on an amount of metals in the Co and Li-containing feed. Preferably, the a sub-stoichiometric amount of sulphuric acid is based on the amount of Co- and Li in the Co and Li-containing feed.

Preferably, the sub-stoichiometric amount of sulphuric acid is 95% or less of the stoichiometric amount of sulphuric acid. More preferably, the sub-stoichiometric amount of sulphuric acid is 90% or less of the stoichiometric amount of sulphuric acid. Even more preferably, the sub-stoichiometric amount of sulphuric acid is 85% or less of the stoichiometric amount of sulphuric acid. Most preferably, the sub-stoichiometric amount of sulphuric acid is 90% or less of the stoichiometric amount of sulphuric acid. Additionally or alternatively, it is preferred that the sub-stoichiometric amount of sulphuric acid is 50% or more of the stoichiometric amount of sulphuric acid. More preferably, the sub-stoichiometric amount of sulphuric acid is 60% or more of the stoichiometric amount of sulphuric acid. Even more preferably, the sub-stoichiometric amount of sulphuric acid is 70% or more of the stoichiometric amount of sulphuric acid. In one form, the sub-stoichiometric amount of sulphuric acid is from about 50 to about 90% of the stoichiometric amount of sulphuric acid.

In an embodiment, a pH of the slurry is maintained at a value of from about 0 to about 4 during the sulphuric acid leach. Preferably the pH is from about 1 to about 2.

In an embodiment, the sulphuric acid leach includes at least two stages:

a first stage of adding from about 10 to about 30% of the total sulphuric acid; and

a second stage of adding a remainder of the total sulphuric acid while sparging with SO₂ gas.

In a preferred form of this embodiment, about 20% of the total sulphuric acid is added during the first stage.

The inventors have found that a two-stage acid leach is particularly advantageous in embodiments where the leachate further includes a dissolved organic phase. This dissolved organic phase can result in significant frothing if treated using a single-stage acid leach. Preferably, during the first stage, the temperature is maintained at or below 75° C. Preferably the temperature is maintained at or below 70° C.

In an embodiment, a pH of the leachate is from about 0 to about 4. Preferably the pH is from about 1 to about 2.

In an embodiment, the leachate has an oxidation-reduction potential (ORP) value that is below the ORP potential of forming ferric iron. In a preferred form, the ORP value is from about 200 mV to about 500 mV (versus a Pt-Ag/AgCl electrode). More preferably, the ORP is from about 200 to about 300 mV.

In an embodiment, the other metal salts include one or more metal salts selected from the group consisting of: Mn, Fe, Ni, Cu, and Al.

In an embodiment, the step of treating the leachate with the air sparge strips excess SO₂ from the leachate and raises the pH of the leachate.

In an embodiment, a base is added to the leachate subsequent to the air sparge so that the Co- and Li-containing leachate has a pH of from about 4 to about 5.

In an embodiment, the other metal salts include at least Fe in the form of FeSO₃, and wherein the step of treating the leachate with the air sparge oxidises and/or converts the FeSO₃ to one or more insoluble iron salts.

In an embodiment, the other metal salts include at least Mn;

wherein when Mn is present in an amount of less than 2 g/L, the step of treating the leachate with the air sparge further includes adjusting the pH to a value of from about 4 to about 5 with a hydroxide to convert the Mn to one or more insoluble Mn salts; or

wherein when Mn is present in an amount of from about 2 g/L to about 5 g/L, the Co- and Li-containing leachate further includes Mn, and prior to the step of treating the Co- and Li-containing leachate with the precipitant, the method further includes:

contacting the leachate with an ion exchange resin to adsorb the Mn from the Co- and Li-containing leachate to a surface of the resin to form an Mn-loaded resin.

Preferably, the method further includes recovering Mn from the Mn-loaded resin.

In an embodiment, the other metal salts include at least Ni;

wherein when Ni is present in an amount of less than 2 g/L, the step of treating the leachate with the air sparge further includes adjusting the pH to a value of from about 4.5 to about 5 to convert the Ni to one or more insoluble Ni salts; or

wherein when Ni is present in an amount of from about 2 g/L to about 5 g/L, the Co- and Li-containing leachate further includes Ni, and prior to the step of treating the Co- and Li-containing leachate with the precipitant, the method further includes:

contacting the leachate with an ion exchange resin to adsorb the Ni from the Co- and Li-containing leachate to a surface of the resin to form an Ni-loaded resin.

Preferably, the method further includes recovering Ni from the Ni-loaded resin.

In an embodiment, the other metal salts include at least Cu;

wherein when Cu is present in an amount of greater than 1 g/L, prior to the step of treating the leachate with the air sparge, the method further includes a copper cementation step to produce metallic Cu, and a separation step of removing metallic Cu from the leachate; or

wherein when Cu is present in an amount of 1 g/L or less, the Co- and Li-containing leachate further includes Cu, and prior to the step of treating the Co- and Li-containing leachate with the precipitant, the method further includes:

contacting the leachate with an ion exchange resin to adsorb the Cu from the Co- and Li-containing leachate to a surface of the resin to form an Cu-loaded resin.

Preferably, the method further includes recovering Cu from the Cu-loaded resin.

In an embodiment, wherein after the step of separating the leachate and the solid residue, and prior to the step of treating the leachate with the air sparge, the method further includes treating the leachate with activated carbon to remove dissolved organic compounds.

The step of treating the Co- and Li-containing leachate with the precipitant may be conducted at any temperature from ambient and up to about 100° C. However, in a preferred embodiment, this step is conducted at a temperature of from about 50 to about 80° C. More preferably, the temperature is form about 55 to about 70° C. Most preferably, the temperature is from about 60 to about 65° C.

In an embodiment, the precipitant used to treat the Co- and Li-containing leachate to form the Co-containing precipitate is a carbonate, such as a Na₂CO₃ or K₂CO₃. Preferably sufficient carbonate is added to raise the pH to a value of about 6.0 to about 8.5, and preferably from about 8.0 to 8.2.

In an embodiment, the Co-containing precipitate is substantially free of other metals. By substantially free of other metals it is meant that the Co-containing precipitate includes less than 1 wt % of non-Co metals; preferably less than 0.5 wt % of non-Co metals; more preferably less than 0.1 wt % of non-Co metals.

In an embodiment substantially all of the cobalt in the leachate is recovered in the Co-containing precipitate. By substantially all, it is meant at least 95 wt % of the cobalt is recovered; preferably at least 97 wt %; more preferably at least 98 wt %; and most preferably at least 99 wt %.

In an embodiment the step of treating the Co- and Li-containing leachate with the precipitant to form the Li-containing leachate and the Co-containing precipitate further includes:

treating the Co- and Li-containing leachate with a sub-stoichiometric amount of the precipitant to form an Li-containing leachate and a Co-containing precipitate corresponding to about 60 to about 90 wt % of the total Co originally in the Co- and Li-containing leachate.

In a preferred form of this embodiment, the step of treating the Co- and Li-containing leachate with the precipitant to form the Li-containing leachate and the Co-containing precipitate further includes:

a post precipitation step including:
adding sufficient precipitant to form a precipitate of residual Co;
separating and recycling the precipitate of residual Co to the leachate.

In a preferred form of this embodiment, the step of treating the Co- and Li-containing leachate with the precipitant to form the Li-containing leachate and the Co-containing precipitate further includes:

a preliminary precipitation step including:
treating the Co- and Li-containing leachate with sufficient precipitant to form an amount of a preliminary Co-containing precipitate corresponding to about 5 to about 20 wt % of the total Co originally in the Co- and Li-containing leachate; and
separating the preliminary Co-containing precipitate from the Co- and Li-containing leachate; and
recycling the preliminary Co-containing precipitate to the leachate.

In an embodiment, the method further includes treating the Li-containing leachate with a precipitant to form a Li -containing precipitate substantially free of other metals. By substantially free of other metals it is meant that the Li-containing precipitate includes less than 1 wt % of non-Li metals; preferably less than 0.5 wt % of non-Li metals; more preferably less than 0.1 wt % of non-Li metals. Preferably, the precipitant is a carbonate or bicarbonate. In cases where the precipitant is bicarbonate, the method preferably includes boiling the Li-containing leachate to form a Li₂CO₃ precipitate.

Further aspects of the present invention and further embodiments of the aspects described in the preceding paragraphs will become apparent from the following description, given by way of example and with reference to the accompanying drawings.

### BRIEF DESCRIPTION OF THE DRAWINGS

FIG. 1: A process flow diagram illustrating an embodiment of the invention.

FIG. 2: XRD spectrum of cobalt precipitate produced according to an embodiment of the invention.

### DETAILED DESCRIPTION OF THE EMBODIMENTS

The description, and the embodiments described therein, is provided by way of illustration of examples of particular embodiments of principles and aspects of the present invention. These examples are provided for the purposes of explanation and not of limitation, of those principles of the invention. In the description that follows, like parts and/or steps are marked throughout the specification and the drawing with the same respective reference numerals.

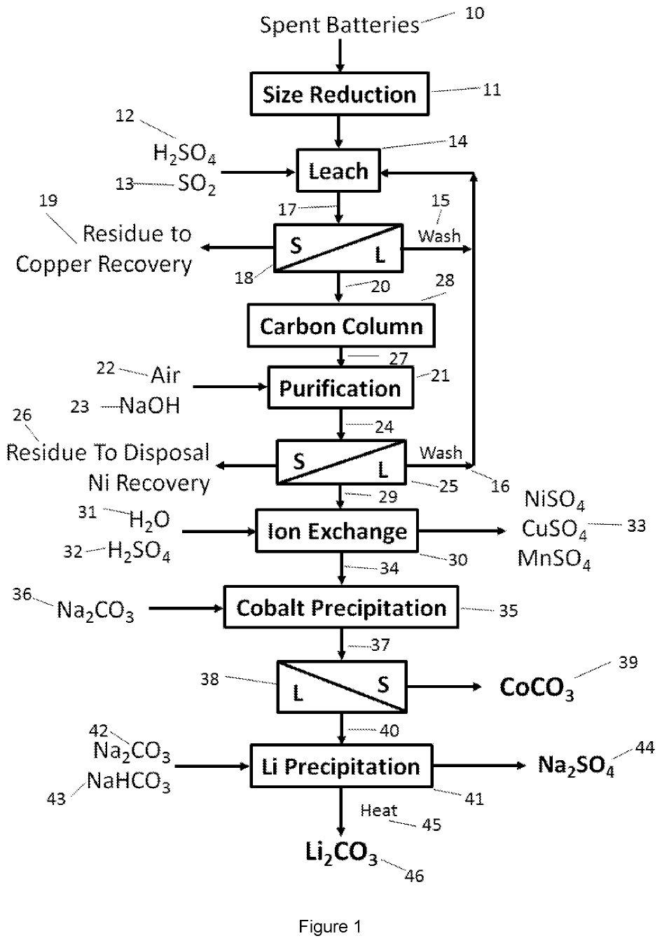

The embodiments of the present invention shall be more clearly understood with reference to the following description and FIG. 1.

FIG. 1 provides a schematic representation of a simple method for treating lithium-cobalt-based spent batteries according to one embodiment of the invention. The scrap batteries 10 first undergo size reduction 11 to generate a Co and Li-containing feed in the form of a coarse powder. Due to the potentially explosive nature of the batteries, this operation is conducted under a blanket of carbon dioxide (CO₂, not shown) which acts both as an explosion suppressant and prevents ingress of air. In this embodiment, a slow stream of CO₂ passes first through an enclosure in which the size reduction 11 occurs, and then is passed through columns of activated carbon and activated alumina to prevent escape of gaseous waste to the atmosphere. The activated carbon column adsorbs the organic mist which emanates from the batteries, and the activated alumina captures any fluorides.

The Co and Li-containing feed then undergoes a reducing leach 14 in sulphuric acid 12 with sulphur dioxide gas 13 addition and recycled wash water 15 and 16. It has been found that in order to maximise metal extraction, and more importantly, minimise frothing, the order in which the acid and SO₂ are added is very important. Frothing occurs because of the nature of the organic-based electrolyte used in the battery manufacture, and can be very problematical if not properly controlled. Thus, 10-30%, preferably 20% of the acid is added prior to any addition of SO₂, and the temperature should not exceed 75° C. This sequence has surprisingly been found to minimise any problems caused by the organics in the leaching circuit.

Thereafter, leaching is initiated by SO₂ addition, and may be carried out at any temperature from ambient to 100° C., but since the reaction is exothermic, the temperature of the reaction tends to settle at a temperature close to 100° C. The acid concentration and solids loading in the leach are adjusted such that a cobalt concentration of 40-100 g/L is obtained, preferably 90-100 g/L, and that the final pH of the solution is in the range from 0.0-4.0, preferably 1.0-2.0. The primary leaching reaction can be described as in equation (2), with similar reactions occurring for nickel and manganese:

2LiCoO₂+SO₂+2H₂SO₄→2CoSO₄+Li₂SO₄+2H₂O (2)

A novel and particular aspect of the current process is to have a sub-stoichiometric amount of sulphuric acid present, and to ensure that there is no oxygen present. This permits additional leaching with SO₂ to take place, and in particular, leads to the formation of soluble sulphites, notably, as shown in equation (3) for iron.

FeO+SO₂→FeSO₃ (3)

Similar reactions occur for nickel and manganese. Unlike ferrous sulphite which is quite soluble, nickel sulphite has a limited solubility at ambient temperatures, as does cobalt sulphite, and thus both will crystallise (not shown in FIG. 1) if the temperature is allowed to cool to ambient. This provides an initial separation of a portion of the cobalt (and nickel).

In reality, a mixture of sulphite and sulphate is formed for all of the metals, since the salts are dissociated in solution. The importance of promoting sulphite formation is that in the subsequent air stripping/neutralisation stage, the amount of base that has to be added is significantly minimised, or eliminated altogether, thus simplifying the process and reducing reagent costs considerably.

The leach may be carried out in any conventional manner, such as, but not limited to, a cascade of CSTRs (Continuous Stirred Tank Reactors). Care is taken to prevent ingress of air into the leach slurry, since reducing conditions need to be maintained for the SO₂ to be effective at this point, especially in the formation of sulphites.

The leach slurry 17 then undergoes solid-liquid separation 18 which may be effected by any convenient means, such as, but not limited to, flocculation and thickening, filter press or vacuum belt filter. The solid residue 19 contains all of the plastics and graphite in the original batteries. It being a reducing leach, copper should not dissolve and aluminium dissolve very, very slowly so that they remain in the leach residue, from which they may be optionally recovered, such as by melting (not shown) of the leach residue. Copper and aluminium being much more dense than plastics sink, and can be separated. However, in practice, it has been found that sometimes both do dissolve. The wash liquor 15 is recycled to the leach.

The leachate/leach solution 20 contains all of the lithium, manganese, iron, nickel, cobalt leached from the scrap batteries 10 and also potentially small amounts of copper and aluminium that may have been leached from the scrap batteries 10. The leach solution 20 also contains significant amounts of dissolved organics which come from the electrolyte in the scrap batteries 10. It has been found that these organics cause considerable problems in the subsequent processing steps, since they are of a very oily nature. Somewhat surprisingly, this has not been mentioned in the literature reviewed above.

The leach solution 20 passes through a column of activated carbon 28, which adsorbs and removes the dissolved organics from the solution. The carbon is periodically stripped and regenerated with steam (not shown).

If significant copper leaching has occurred, and there is >1 g/L Cu in solution, it has been found preferential to remove the copper at this point in the process, rather than overload a subsequent ion exchange circuit. This can be achieved by cementation with iron powder (not shown). The reaction involved is:

CuSO₄+Fe→Cu+FeSO₄ (4)

Due to the reducing nature of the solution 20, this reaction is extremely effective, and pure metallic copper powder is obtained.

The treated leachate (also referred to as a clean solution) 27 then undergoes purification 21. This is achieved in one of two ways, depending on the free SO₂ of the solution. In the first instance, this can be by sparging in air 22, which undertakes a number of roles. Firstly, it strips any excess SO₂ from the solution. Secondly, it combines with the dissolved free SO₂ in the solution to oxidise ferrous to ferric sulphate, as shown in reaction (5). In essence, the combination of air and SO₂ transiently forms peroxy monosulphuric acid, H₂S₂O₅, which is a moderately powerful oxidant.

2FeSO₄+3SO₂+2O₂+2H₂O→Fe₂(SO₄)₃+2H₂SO₄ (5)

Simultaneously, some of the manganese is also oxidised to its +3 and/or +4 valence state, and following adjustment of the pH to 4.0-5.0, preferably 4.5, with caustic soda 23, it will precipitate along with the iron. This is appropriate where the manganese content in the treated leachate 27 is low, such as in when manganese is present in an amount that is less than 2 g/L.

Aluminium may also be removed during this stage if it is present in the treated leachate 27.

An important and novel role of air 22 is to decompose and oxidise the ferrous sulphite, forming goethite and stripping the SO₂ so-liberated out of solution, as shown in equation (6):

4FeSO₃+O₂+2H₂O→4FeOOH+4SO₂ (6)

It is apparent from this reaction the dissolved iron is hydrolysed to form goethite without the addition of any base, and without the formation of any protons. This advantageously allows both neutralisation and purification of the iron in the sulphite form to take place without the need to add base, unlike with conventional processing.

If the initial pH of the solution 27 is between 1.0 and 1.5, the presence of a monovalent alkali, lithium, can promote the formation of jarosite as shown in equations (7).

3Fe₂(SO₄)₃+Li₂SO₄+H₂O→2LiFe₃(OH)₆(SO₄)₂+3H₂SO₄ (7)

This is desirable from one aspect, in that coarse crystals of jarosite are formed, which promote rapid filtering of the solids. On the other hand, this reaction releases protons, which require subsequent neutralisation with a base 23. It is preferential to avoid the formation of jarosite.

The slurry 24 then undergoes solid-liquid separation 25 which may be effected by any convenient means, such as, but not limited to, flocculation and thickening, filter press or vacuum belt filter. The wash liquor 16 is recycled to the leach.

Depending upon the amount of nickel in the feed, the precipitate of insoluble metal salts (in the form of cake 26) can contain a significant proportion of the nickel and cobalt, and may be re-leached, if warranted, to effect nickel recovery. In some instances, the cake may include up to about 15% cobalt in the case of a treated leachate 27 containing 60 g/L of cobalt, and up to about 75% nickel in the case of a treated leachate containing 5 g/L of nickel. That is, in one or more embodiments, the method further includes leaching the precipitate insoluble metals (e.g. the cake) tp recpver cobalt and/or nickel. Depending on the amount of nickel in the feed, the final pH of the purification process 21 is adjusted to between 4.0 and 5.0. In order to minimise co-precipitation of nickel and cobalt, then a value between 4.0 and 4.2 is preferred, whereas if the initial nickel content is low, such as less than about 2 g/L, and does not warrant recovery, then it is preferable to remove the nickel here, and pH a value between 4.5 and 5.0 is adopted.

The solution 29 proceeds to ion exchange 30 for the removal of residual nickel, copper and manganese. Depending on the levels remaining, ion exchange may be effected by three separate stages, one for each metal, or by a combined operation, where three resins are mixed in a single bed. Resins for the removal of these ions are known to those skilled in the art, such as, but not limited to, an iminodiacetate resin for copper, such as Dowex IRC 748; an aminomethyl phosphonic acid resin for manganese, such as Dowex IRC 747; and a bis-picolylamine resin, such as Dowex M4195 for nickel. Another especially effective resin for nickel is an anionic resin with a complex amine functionality, such as Purolite A830.

FIG. 1 illustrates a mixed bed concept in which nickel, copper, and manganese are removed in a combined operation. The loaded resin is backwashed with water 21, which is recycled to the leach 14, and then stripped with sulphuric acid 32. The eluate 33, containing copper, nickel and manganese sulphates may be treated separately for the recovery of these metals, or disposed of.

The ion exchange barren solution 34 proceeds to cobalt carbonate precipitation 35. This is carried out through the addition of soda ash solution 36. Depending on the effectiveness of the purification and ion exchange circuits, precipitation may be effected in one, two or three stages, with the first and last stages, representing 5-20% of the overall cobalt, recycled to the head of the purification circuit 21. Equation (8) shows the reaction.

CoSO₄+Na₂CO₃→CoCO₃+Na₂SO₄ (8)

The precipitation is carried out at any temperature from ambient to 100° C., preferably 50-80° C., and most preferably at 60-65° C. The optimum pH for precipitation is 6.0-8.5, and preferably 8.0-8.2, which allows for coarse, crystalline carbonate to be formed, and recovers essentially all of the cobalt from solution.

The precipitation slurry 37 then undergoes solid-liquid separation 38 which may be effected by any convenient means, such as, but not limited to, flocculation and thickening, filter press or vacuum belt filter. The solids are washed, yielding high purity cobalt carbonate 39.

The filtrate 40 is essentially a pure mixture of lithium and sodium sulphates. If warranted, lithium may be recovered 41 by the further addition of sodium carbonate 42 or bicarbonate 43 to pH 9, followed by boiling 45, to recover lithium carbonate 46. The remaining solution is predominantly sodium sulphate 44.

### EXAMPLE 1

A sample (250 g) of shredded and hammer-milled spent battery was leached with sulphuric acid and SO₂ at 90° C. for four hours. 80% of the stoichiometric amount of sulphuric acid (for lithium and cobalt) was added prior to SO₂ addition. 50% of the mass was leached, and cobalt extraction was 96.4%, with an equivalent amount of lithium. Significant frothing was observed.

This example demonstrates that cobalt can be extracted from the batteries with sub-stoichiometric addition of sulphuric acid.

### EXAMPLE 2

The leach filtrate from the above test was sparged with air for 6 hours at 90° C. After only 60 minutes, however, the pH of the solution had risen to 4.0. Filtration showed brown solids typical of goethite, interspersed with bright yellow crystals characteristic of jarosite. The iron content of the solution was reduced from 12.4 down to 0.8 g/L, representing removal of 92% of the iron from solution. 43% of the manganese and 79% of the nickel were also removed, leaving a solution with 0.9 g/L each of those two metals, which is ideal for ion exchange polishing.

This example demonstrates the removal of iron, manganese and nickel by simply sparging with air, and without the need for any base addition.

### EXAMPLE 3

Filtrate from the above test was re-circulated overnight through a bed of ion exchange resin Purolite A830. The nickel concentration dropped from 0.9 g/L down to 27 mg/L. This demonstrates the effectiveness of ion exchange for removing nickel from cobalt sulphate solution.

### EXAMPLE 4

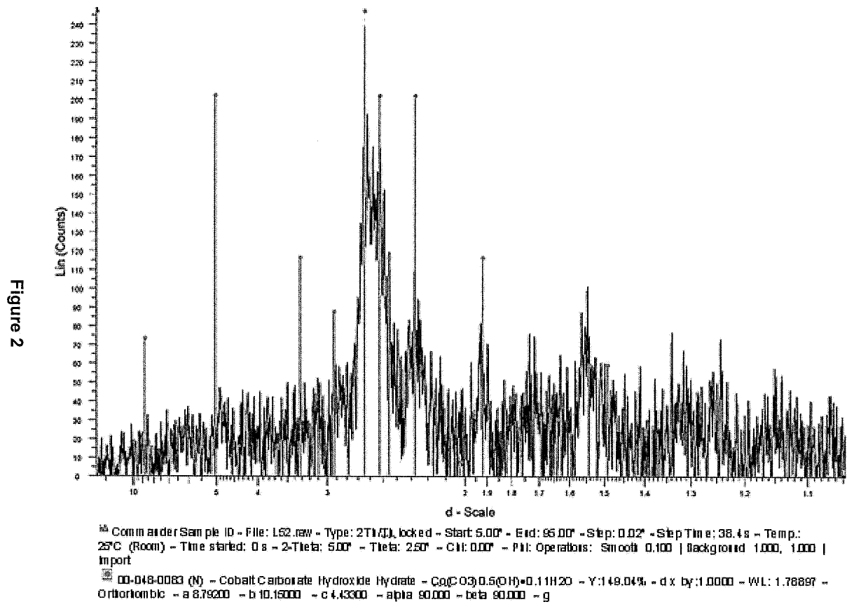

Purified cobalt sulphate/lithium sulphate solution was heated up to 60° C., and sodium carbonate solution (20%) was added to pH 8.2. A pink precipitate was formed, which filtered easily. The final filtrate did not have any detectable cobalt, indicating 100% recovery, and the cobalt carbonate solids had no detectable lithium, with a purity of >99.9%. XRD analysis (see FIG. 2) of the pink solids showed CoCO₃.xH₂O, the common form of cobalt carbonate.

This example demonstrates that cobalt can be selectively precipitated as its carbonate from a mixed lithium/cobalt solution with very high recovery.

It will be understood that the invention disclosed and defined in this specification extends to all alternative combinations of two or more of the individual features mentioned or evident from the text or drawings. All of these different combinations constitute various alternative aspects of the invention.

1. A method for recovering metals from waste lithium and cobalt containing feeds, including:
subjecting shredded and/or pulverised Li-battery waste to a sulphuric acid leach and sparging with SO₂ gas to form a slurry including a leachate of soluble metal salts and a solid residue, wherein the soluble metal salts are a mixture of Co- and Li-salts and other metal salts in the form of metal sulphites and metal sulphates;
separating the leachate and the solid residue;
treating the leachate with an air sparge to oxidise and/or convert at least some of the soluble metal salts to insoluble metal salts, and form a Co- and Li-containing leachate and a precipitate of insoluble metal salts;
separating the Co- and Li-containing leachate and the precipitate of insoluble metal salts;
treating the Co- and Li-containing leachate with a precipitant to form an Li-containing leachate and a Co-containing precipitate; and
separating the Co-containing precipitate from the Li-containing leachate.

2. The method of claim 1, wherein the sulphuric acid leach and sparging with SO₂ are conducted under anoxic conditions.

3. The method of claim 1, wherein sufficient sulphuric acid solution is added during the leach to provide a cobalt concentration of about 40 g/L to about 100 g/L.

4. The method of claim 1, wherein a sub-stoichiometric amount of sulphuric acid is used in the sulphuric acid leach, based on an amount of metals in the Li-battery waste.

5. The method of claim 4, wherein the sub-stoichiometric amount of sulphuric acid is from about 50 to about 90% of the stoichiometric amount of sulphuric acid.

6. The method of claim 1, wherein a pH of the slurry is maintained at a value of from about 0 to about 4 during the sulphuric acid leach.

7. The method of claim 1, wherein the sulphuric acid leach includes at least two stages:
a first stage of adding from about 10 to about 30% of the total sulphuric acid; and
a second stage of adding a remainder of the total sulphuric acid while sparging with SO₂ gas.

8. The method of claim 7, wherein during the first stage, the temperature is maintained at or below 75° C.

9. The method of claim 1, wherein the other metal salts include one or more metal salts selected from the group consisting of: Mn, Fe, Ni, Cu, and Al.

10. The method of claim 1, wherein the other metal salts include at least iron in the form of iron sulphite, and wherein the step of treating the leachate with the air sparge oxidises and/or converts the iron sulphite to one or more insoluble iron salts.

11. The method of claim 1, wherein the other metal salts include at least Mn;
wherein when Mn is present in an amount of less than 2 g/L, the step of treating the leachate with the air sparge further includes adjusting the pH to a value of from about 4 to about 5 with a hydroxide to convert the Mn to one or more insoluble Mn salts; or
wherein when Mn is present in an amount of from about 2 g/L to about 5 g/L, the Co- and Li-containing leachate further includes Mn, and prior to the step of treating the Co- and Li-containing leachate with the precipitant, the method further includes:
contacting the leachate with an ion exchange resin to adsorb the Mn from the Co- and Li-containing leachate to a surface of the resin to form an Mn-loaded resin.

12. The method of claim 11, wherein the method further includes recovering Mn from the Mn-loaded resin.

13. The method of claim 1, wherein the other metal salts include at least Ni;
wherein when Ni is present in an amount of less than 2 g/L, the step of treating the leachate with the air sparge further includes adjusting the pH to a value of from about 4.5 to about 5 to convert the Ni to one or more insoluble Ni salts; or
wherein when Ni is present in an amount of from about 2 g/L to about 5 g/L], the Co- and Li-containing leachate further includes Ni, and prior to the step of treating the Co- and Li-containing leachate with the precipitant, the method further includes:
contacting the leachate with an ion exchange resin to adsorb the Ni from the Co- and Li-containing leachate to a surface of the resin to form an Ni-loaded resin.

14. The method of claim 13, wherein the method further includes recovering Ni from the Ni-loaded resin.

15. The method of claim 1, wherein the other metal salts include at least Cu;
wherein when Cu is present in an amount of greater than 1 g/L, prior to the step of treating the leachate with the air sparge, the method further includes a copper cementation step to produce metallic Cu, and a separation step of removing metallic Cu from the leachate; or
wherein when Cu is present in an amount of 1 g/L or less, the Co- and Li-containing leachate further includes Cu, and prior to the step of treating the Co- and Li-containing leachate with the precipitant, the method further includes:
contacting the leachate with an ion exchange resin to adsorb the Cu from the Co- and Li-containing leachate to a surface of the resin to form an Cu-loaded resin.

16. The method of claim 15, wherein the method further includes recovering Cu from the Cu-loaded resin.

17. The method of claim 1, wherein after the step of separating the leachate and the solid residue, and prior to the step of treating the leachate with the air sparge, the method further includes treating the leachate with activated carbon to remove dissolved organic compounds.

18. The method of claim 1, wherein the step of treating the Co- and Li-containing leachate with the precipitant to form the Li-containing leachate and the Co-containing precipitate further includes:
a preliminary precipitation step including:
treating the Co- and Li-containing leachate with sufficient precipitant to form an amount of a preliminary Co-containing precipitate corresponding to about 5 to about 20 wt % of the total Co originally in the Co- and Li-containing leachate; and
separating the preliminary Co-containing precipitate from the Co- and Li-containing leachate; and
recycling the preliminary Co-containing precipitate to the leachate.

19. The method of claim 1, wherein the Co-containing precipitate is substantially free of other metals.

20. The method of claim 1, wherein the method further includes treating the Li-containing leachate with a precipitant to form an Li-containing precipitate substantially free of other metals.
